(19) United States
(12) Patent Application Publication
(10) Pub. No.: US 2004/0087707 A1
(43) Pub. Date: May 6, 2004

(54) Aqueous, colloidal, freeze-resistant and storage-stable gas black suspension

(76) Inventors: Heinz Zoch, Maintal (DE); Werner Kalbitz, Rodenbach (DE); Stephan Ludtke, Maintal (DE); Thomas Luthge, Hanau (DE); Gerd Tauber, Seligenstadt (DE)

Correspondence Address: SMITH, GAMBRELL & RUSSELL, LLP, SUITE 3100, PROMENADE II, 1230 PEACHTREE STREET, N.E., ATLANTA, GA, 30309-3592, US

(21) Appl. No.: 10/627,501

(22) Filed: Jul. 25, 2003

(30) Foreign Application Priority Data
Jul. 31, 2002 (DE) 102 35 027.2

(51) Int. Cl. C08J 3/00

(52) U.S. Cl. 524/495; 524/556

(57) ABSTRACT

Aqueous, colloidal, freeze-resistant and storage-stable gas black suspension are disclosed containing 2-30 wt. % gas black, 0-40 wt. % carbon black, a dispersion-supporting additive, a biocide and water and having a zeta potential of less than −10 mV, a surface tension of greater than 50 mN/m and an average particle size of less than 200 nm. The aqueous, colloidal, freeze-resistant and storage-stable gas black suspension is produced by dispersing the gas black and the carbon black in water together with the dispersion-supporting additive and biocide. Inks, ink-jet inks, lacquers and printing inks can be made from these suspensions.

### INTRODUCTION AND BACKGROUND

The present invention relates to aqueous, colloidal, freeze-resistant and storage-stable gas black suspensions, a process for production and use thereof.

Aqueous, colloidal carbon black suspensions are used for the production of lacquers and printing inks or directly as inks, for example in inkjet printers.

The use of pigment blacks in inkjet inks is known (U.S. Pat. No. 5,085,698, U.S. Pat. No. 5,320,668). Water-soluble acrylates inter alia are used therein for pigment stabilization.

In addition, aqueous carbon black suspensions are known with carbon blacks whose average primary particle size is no greater than 30 nm and whose DBP value is at least 75 ml/100 g (U.S. Pat. No. 5,538,548).

The production of aqueous carbon black suspensions using water-soluble organic solvents and water-soluble acrylic resins is also known (U.S. Pat. No. 5,609,671).

The disadvantage of the known carbon black suspensions is the need to add to the suspensions, in addition to the actual wetting agent to stabilize the pigment, additional auxiliary substances to improve applicational properties such as degree of dispersion, storage stability at room temperature, freeze resistance, optical density, viscosity, zeta potential and particle size distribution.

The addition of wetting agent and auxiliary substances restricts the flexibility of use of the suspension. The risk of incompatibilities in the corresponding final formulation increases, and special suspensions have to be developed for special applications.

A further disadvantage of adding wetting agent and auxiliary substances, which are generally soluble or miscible organic substances, is their toxic or ecotoxic potential. In particular, relatively highly volatile compounds hold the risk of being absorbed by inhalation during use.

### SUMMARY OF THE INVENTION

The object of the present invention is to provide an aqueous gas black suspension that requires no auxiliary substances to establish the desired applicational properties, such as e.g. degree of dispersion, storage stability, freeze resistance, optical density, viscosity, zeta potential and particle size distribution.

The invention provides an aqueous, colloidal, freeze-resistant and storage-stable gas black suspension, which is characterized in that it comprises 2-30 wt. %, preferably 10-25 wt. %, gas black, 0-40 wt. %, preferably 0-30 wt. %, carbon black, a dispersion-supporting additive, a biocide and water, and the zeta potential is less than −10 mV, preferably less than −25 mV, the surface tension is greater than 50 mN/m, preferably greater than 60 mN/m, and the average particle size is less than 200 nm, preferably less than 100 nm.

As used herein, colloidal refers to the uniform distribution of particles of diameter 10 nm-10 μm in a suspending agent. For use in inks, depending on the printing process, a low viscosity is advantageous in order to obtain the desired printing properties, for example print sharpness. A low zeta potential, which describes the charge status of the particles in the carbon black suspension, is a measure of good suspension stability. A high surface tension has a positive influence on droplet formation, for example in the inkjet process. A high degree of dispersion is of substantial importance for good storage stability, for good coloristic properties in the application and for the prevention of nozzle clogging, especially in the inkjet process.

The pH of the aqueous, colloidal gas black suspension can be 6-12, preferably 8-10.

The gas black can display a primary particle size of 8-40 nm and a DBP value of 40-200 ml/100 g. The gas black can also be a mixture of various gas blacks. Examples of gas blacks that can be used include Color Black FW 200, Color Black FW 2, Color Black FW 2 V, Color Black FW 1, Color Black FW 18, Color Black S 170, Color Black S 160, Special Black 6, Special Black 5, Special Black 4, Special Black 4A, NIPex 150, NIPex 160 IQ, NIPex 170 IQ, NIPex 180 IQ, Printex U, Printex V, Printex 140 U or Printex 140 V from Degussa AG.

Pigment blacks having an average primary particle size of 8 to 80 nm, preferably 10 to 45 nm, and a DBP value of 40 to 200 ml/100 g, preferably 60 to 150 ml/100 g, can be used as the carbon black. Pigment blacks produced by the furnace, channel or lamp black process can also be used as carbon blacks. Examples thereof are Printex 95, Printex 90, Printex 85, Printex 80, Printex 75, Printex 55, Printex 45, Printex 40, Printex P, Printex 60, Printex XE 2, Printex L 6, Printex L, Printex 300, Printex 30, Printex 3, Printex 35, Printex 25, Printex 200, Printex A, Printex G, Special Black 550, Special Black 350, Special Black 250, Special Black 100, Lamp Black 101, NIPex 35, NIPex 60, NIPex 70 or NIPex 90.

The biocide can be added in quantities of 0.01-1.0 wt. %. Isothiazolinone derivatives, formaldehyde separators or combination products of the two product classes can be used as the biocide. For example, Parmetol from Schülke & Mayr, Ebotec from Bode Chemie, Acticide from Thor Chemie or Proxel from Zeneca can be used as the biocide.

The dispersion-supporting additive can be added in quantities of 1-50 wt. %, preferably 3-20 wt. %, relative to the total suspension. The molecular weight of the dispersion-supporting additive can be 1000 to 20000 g/mol, preferably 14500 to 17000 g/mol. The acid value of the dispersion-supporting additive can be 120 to 320, preferably 180 to 280. Styrene-acrylic acid copolymers can be used as the dispersion-supporting additive. The copolymers can be random, alternating, block or graft copolymers. For example, Joncryl 678, Joncryl 680, Joncryl 682 or Joncryl 690 from Johnson Polymer B.V. can be used as the dispersion-supporting additive.

In a preferred embodiment, forms of styrene-acrylic acid copolymers that are completely neutralized with ammonium or alkali hydroxide, in particular forms neutralized with NaOH, can be used as the dispersion-supporting additive.

Other types of dispersion-supporting additives are not suitable for producing the gas black suspension according to the invention, as becomes clearly apparent from certain properties, for example the degree of dispersion, surface tension, storage stability or freeze resistance.

By keeping to certain limiting values for typical suspension characteristics, such as gas black content, zeta potential, pH, surface tension and average particle size, an aqueous, colloidal gas black suspension can be obtained that is freeze-resistant and stable in storage.

### BRIEF DESCRIPTION OF DRAWINGS

The present invention will be further understood with reference to the drawings, wherein FIGS. 1A, 1B and IC are micrographs of carbon black suspensions made in accordance with Example 1 and Table 1; and

FIGS. 2A, 2B, 2C and 2D are micrographs of carbon black suspensions made in accordance with Example 2 and Table 2.

### DETAILED DESCRIPTION OF INVENTION

The invention also provides a process for producing the aqueous, colloidal, freeze-resistant and storage-stable gas black suspensions of this invention, which comprises dispersing the gas black and optionally the carbon black in water together with the dispersion-supporting additive and biocide.

Dispersion can be performed with bead mills, ultrasonic devices, high-pressure homogenizers, a Microfluidizer, Ultra-Turrax or other comparable equipment. Following dispersion the aqueous, colloidal, freeze-resistant and storage-stable carbon black suspension can be purified by centrifugation and/or filtration.

The invention also provides the use of the aqueous, colloidal, freeze-resistant and storage-stable gas black suspensions according to the invention in inks, inkjet inks, lacquers and printing inks. Hence, the present invention provides compositions suitable for these purposes.

When using the aqueous, colloidal, freeze-resistant and storage-stable gas black suspension according to the invention there is no need to add further auxiliary substances for the various applications to improve the suspension properties. Thus, the compositions of the present invention are free of auxiliary substances and wetting agents used in prior known formulations to improve suspension properties.

This invention also provides an ink which is characterized in that it contains the aqueous, colloidal, freeze-resistant and storage-stable gas black suspension according to the invention.

The advantages of the gas black suspensions according to the invention are their good storage stability and freeze resistance, high degree of dispersion and optical density and low particle size, viscosity and zeta potential, without the need to add auxiliary substances.

The avoidance of auxiliary substances means that no organic, soluble substances are released that have a corresponding toxic or ecotoxic potential.

A further advantage of the aqueous, colloidal, freeze-resistant and storage-stable gas black suspension according to the invention is that there is no agglomeration tendency if organic solvents are added.

### EXAMPLES

### Example 1

### Comparison of Gas Black and Furnace Black

The formulation used for the carbon black suspension is shown in Table 1.

TABLE 1

| | | | Gas black |
|---|---|---|---|
| | | | suspension 1 |
| | Reference | Reference | according to |
| | suspension 1 | suspension 2 | the invention |
| Gas black NIPex 160 IQ | — | — | 15 wt. % |
| Furnace black Printex 95 | 30 wt. % | — | — |
| Furnace black Printex 90 | — | 15 wt. % | — |
| Joncryl 690 | 30 wt. % | 15 wt. % | 15 wt. % |
| (35% resin solution) | | | |
| Biocide Acticide MBS | 0.3 wt. % | 0.3 wt. % | 0.3 wt. % |
| Water | 39.7 wt. % | 69.7 wt. % | 69.7 wt. % |

Joncryl 690 is a styrene-acrylic acid copolymer from Johnson Polymer B.V. The biocide Acticide MBS is a combination product comprising methyl-4-isothiazolin-3-one and 1,25 benzisothiazolin-3-one from Thor Chemie. The furnace blacks Printex 95 (BET surface area 250 m²/g, DBP 52 ml/100 g) and furnace blacks Printex 90 (BET surface area 300 m²/g, DBP 100 ml/100 g) are carbon blacks from Degussa AG. The gas black NIPex 160 IQ is a carbon black with a BET surface area of 150 m²/g and an average primary particle size of 20 nm from Degussa AG.

The carbon black suspensions are produced as follows:

1. Preparation of the dispersion-supporting additive

The water and the quantity of styrene-acrylic acid copolymer are prepared and 33% NaOH solution is carefully added dropwise with stirring until a pH of 9 is achieved.

2. Incorporation of the carbon black

The carbon black is gradually incorporated into the prepared dispersion-supporting additive solution whilst stirring slowly (either by hand or with a slow mixer).

3. Dispersion

The suspension prepared in step 2 is dispersed using an ultrasonic device. Very coarse particles can be separated from the suspension thus obtained in a centrifuge.

Examination of the degree of dispersion by light microscopy:

The degree of dispersion of the carbon black suspension samples is assessed at 400× magnification. At this setting coarse particles >1 μm can be readily detected using the scaling on the microscope.

Micrographs of the carbon black suspensions are shown in FIGS. 1A-1C.

The gas black suspension according to the invention, shown in FIG. 1C, displays a significantly higher degree of dispersion than the reference suspensions with the furnace blacks. Even without auxiliary substances the gas black suspension according to the invention displays very high degrees of dispersion.

### Example 2

### Comparison of Dispersion-Supporting Additives

The formulation used for the carbon black suspension is shown in Table 2.

TABLE 2

| | | | | Gas black |
|---|---|---|---|---|
| | | | | suspension 2 |
| | Reference | Reference | Reference | according to |
| | suspension 3 | suspension 4 | suspension 5 | the invention |
| Gas black | 15 wt. % | 15 wt. % | 15 wt. % | — |
| FW 18 | | | | |
| Gas black | — | — | — | 15 wt. % |
| NIPex 160 IQ | | | | |
| Joncryl 690 | — | — | — | 15 wt. % |
| (35% resin | | | | |
| solution) | | | | |
| MA-CP | 10 wt. % | — | — | — |
| PVP | — | 8 wt. % | — | — |
| Fatty alcohol | — | — | 10 wt. % | — |
| glycol ether | | | | |
| sulfate | | | | |
| AMP 90 | 0.3 wt. % | 0.2 wt. % | 0.2 wt. % | — |
| Biocide | 0.3 wt. % | 0.3 wt. % | 0.3 wt. % | 0.3 wt. % |
| Acticide MBS | | | | |
| Water | 74.4 wt. % | 76.5 wt. % | 74.5 wt. % | 69.7 wt. % |

PVP is polyvinyl pyrolidone from GAF. MA-CP is Tego Dispers 750 W, a styrene-maleic anhydride copolymer from Tego. Fatty alcohol glycol ether sulfate is Disponil FES 3215 from Cognis. AMP 90 is 2-amino-2-methyl-1-propanol solution from Angus Chemie.

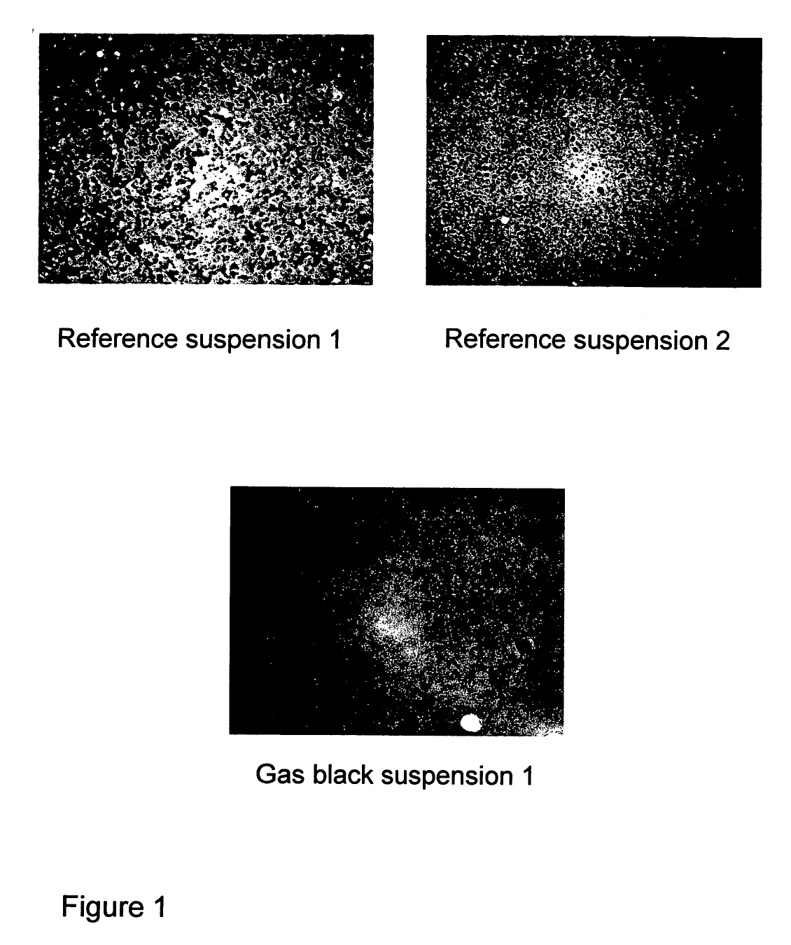

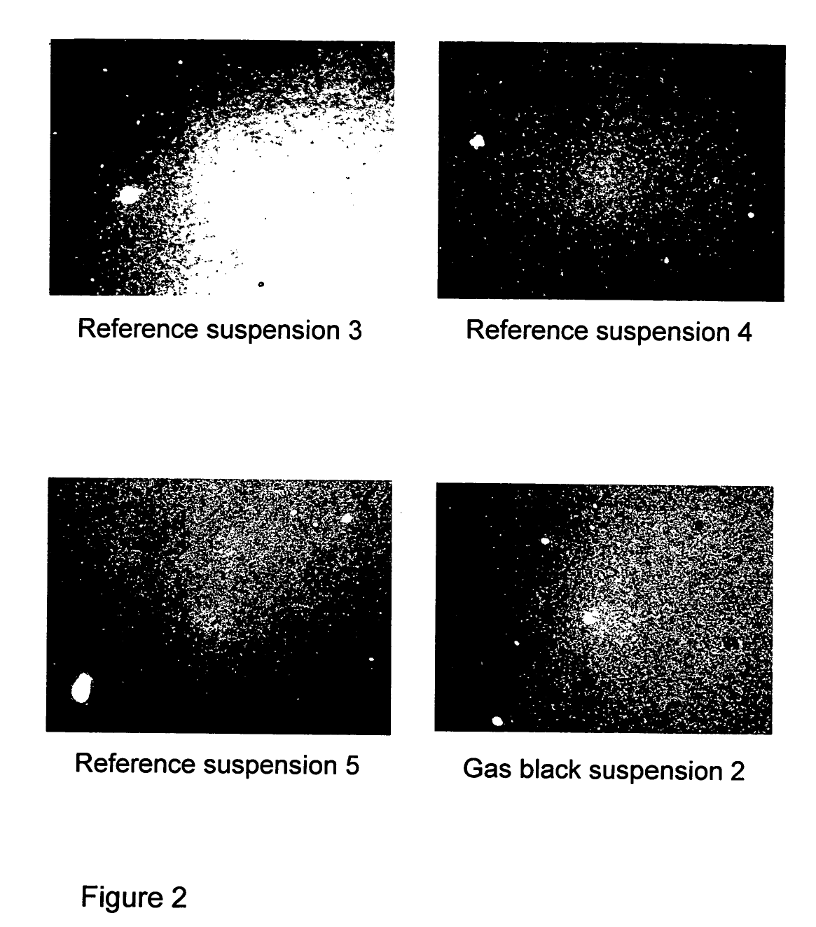

Reference mixture 5 (FIG. 2C) displays a poorer degree of dispersion than the gas black suspension according to the invention, see FIG. 2D.

Various suspension properties are summarized in Table 3.

TABLE 3

| | | | | | Gas black |
|---|---|---|---|---|---|
| | | | | | suspension |
| | | Reference | Reference | Reference | 2 according |
| | | suspension | suspension | suspension | to the |
| | Requirements | 3 | 4 | 5 | invention |
| Ability to | Yes | + | + | + | + |
| produce a 15% | | | | | |
| gas black | | | | | |
| suspension | | | | | |
| Degree of | No particles | + | + | − | ++ |
| dispersion (light | >1 μm | | | | |
| microscope) | | | | | |
| Average particle | <100 nm | −(125) | +(89) | +(88) | +(92) |
| size [nm] | | | | | |
| Freeze resistance | Yes | — | + | + | + |
| Surface tension | >60 mN/m | −(50.1) | ++(63) | −(38) | ++(65) |
| [mN/m] | | | | | |
| pH | 8-9 | +(8.9) | +(8.7) | +(8.8) | +(8.6) |
| Viscosity [mPas] | <15 mPas | +(11.1) | −(17.0) | ++(5.7) | ++(8.2) |
| Zeta potential | <−20 mV | −(−7) | −(−5) | −(−15) | ++(−31) |
| [mV] | | | | | |
| Storage stability | Yes | −(Sharp rise | + | + | + |
| 50° C., 35 d | (No | in viscosity) | | | |
| | sedimentation or | | | | |
| | reagglomer- | | | | |
| | ation and no rise | | | | |
| | in viscosity) | | | | |

−does not meet the requirements
+meets the requirements
++far exceeds the requirements

Determining the viscosity:

The rheological performance is measured in a rotation experiment with a constant shear rate (CSR) using a Physica USD 200 rheometer. The viscosity is read off at a shear rate of 1000 s⁻¹.

Determining the average particle size:

The particle size distribution is determined using a Horiba LB-500 photon correlation spectrometer (PCS) and the “median value” displayed is read off as the average particle size. The measurement is obtained using an undiluted suspension sample.

Determining the surface tension:

The dynamic surface tension is measured using a BP2 bubble tensiometer supplied by Krüss.

The final reading is taken at 3000 ms.

Storage stability test at 50° C. over 28 days:

The samples are stored for 28 days at 50° C. in a drying oven. The viscosity and sedimentation tendency are checked.

A 300 ml sample of suspension is stored in a closed glass flask for 28 days at 50° C. in a drying oven. The formation of sediment at the bottom is checked with a spatula and the viscosity measured with a Brookfield DV II plus viscometer. In addition, sediment formation is tested in a number of samples stored at room temperature.

Freeze resistance test:

The samples are frozen and the degree of dispersion checked using a light microscope after thawing.

A sample is judged to be freeze-resistant if after being thawed the frozen sample again has a highly liquid consistency, forms no sediment and no reagglomerations are visible under the light microscope.

The colloidal gas black suspensions according to the invention in particular satisfy all the requirements of an optimum suspension.

Inks with a 5% carbon black content are prepared from the carbon black suspension samples with ink additives such as 2-pyrrolidone, 1,3-propanediol, glycerine and deionized water. To this end the premix of ink additives is prepared and the carbon black suspension carefully added with stirring. The prepared ink is filtered with a filter fineness of 500 nm. 6 μm drawdowns are then produced on copier paper (Kompass Copy Office) using a K Control Coater coating device and the optical density measured after 24 h using a densitometer.

The printing tests are performed using a Canon BJC-S450 office printer. To this end the ink is first deaerated under vacuum and introduced into a cleaned original printer cartridge.

The results are presented in Table 4.

TABLE 4

| | | | | Gas black |
|---|---|---|---|---|
| | Reference | Reference | Reference | suspension 2 |
| | suspension | suspension | suspension | according to |
| | 3 | 4 | 5 | the invention |
| Light microscope | o | o | o | + |
| pH | 8.6 | 8.7 | 8.6 | 8.7 |
| Viscosity, 23° C. | 3.4 | 3.7 | 2.9 | 3.1 |
| [mPas] | | | | |
| Surface tension | 47 | n.d. | n.d. | 46 |
| [mN/m] | | | | |
| Optical density (OD) | 1.39 | 1.34 | 1.26 | 1.41 |
| on Kompass Copy | | | (blotchy) | |
| Office copier paper | | | | |
| OD on HP 51634 Z | 1.49 | 1.43 | 1.58 | 1.51 |
| inkjet paper | | | | |
| OD on Canon HR-101 | 1.53 | 1.54 | 1.58 | 1.60 |
| inkjet paper | | | | |
| OD on Epson 720 dpi | 1.51 | 1.53 | 1.58 | 1.56 |
| inkjet paper | | | | |
| Proof copy after 5 | −** | −** | + | + |
| min interval | | | | |
| Proof copy after 10 | −** | −** | + | + |
| min interval | | | | |
| Proof copy after 20 | −** | −** | + | + |
| min interval | | | | |
| Proof copy after 30 | −** | −** | + | + |
| min interval | | | | |
| Proof copy after 60 | −** | −** | + | + |
| min interval | | | | |
| Nozzle clogging | yes | yes | no | no |
| Surface drying at print | yes | yes | no | no |
| head | | | | |
| Proof copy after 1 day | n.d. | n.d. | + | + |
| interval | | | | |
| Proof copy after 7 day | n.d. | n.d. | + | + |
| interval | | | | |
| Overall assessment of | − | − | o | + |
| printed image | | | | |

+ = good;
o = adequate;
− = poor;
**transfer problems

Determining the pH:

The pH is determined from the undiluted suspension.

The following printing tests are performed:

a. Printing one page onto copier paper and onto various commercial inkjet papers to determine the optical density and for a visual assessment of the print quality.

b. Printing one page after printing intervals of 5, 10, 20, 30 and 60 minutes to assess the transfer and surface drying behaviour of the ink.

c. Refire tests after a printing interval of 1 and 7 days.

The ink according to the invention is characterized by very good printability, high optical densities and very good storage stability.

Variations and modifications of the foregoing will become apparent to those skilled in the art and are intended to be encompassed by the claims appended hereto.

German priority application 1 02 35 027.2 of Jul. 31, 2002 is relied on and incorporated herein by reference.

We claim:

1. An aqueous, colloidal, freeze-resistant and storage-stable gas black suspension, comprising 2-30 wt. % gas black, 0-40 wt. % carbon black, a dispersion-supporting additive, a biocide and water, and having a zeta potential of less than 10 mV, a surface tension of greater than 50 mN/m and an average particle size of less than 200 nm.

2. The aqueous, colloidal, freeze-resistant and storage-stable gas black suspension according to claim 1, wherein the dispersion-supporting additive is styrene-acrylic acid copolymer.

3. The aqueous, colloidal, freeze-resistant and storage-stable gas black suspension according to claim 2, wherein the styrene-acrylic acid copolymer is completely neutralized with ammonium or alkali hydroxide.

4. The aqueous, colloidal, freeze-resistant and storage stable gas black suspension according to claim 1, wherein the zeta potential is less than −25 mV.

5. The aqueous, colloidal, freeze-resistant and storage stable gas black suspension according to claim 1, wherein the surface tension is greater than 60 mN/m.

6. The aqueous, colloidal, freeze-resistant and storage stable gas black suspension according to claim 1, wherein the average particle size is less than 100 nm.

7. The aqueous, colloidal, freeze-resistant and storage stable gas black suspension according to claim 1, which has a pH of 6 to 12.

8. The aqueous, colloidal, freeze-resistant and storage stable gas black suspension according to claim 1, wherein the gas black has an average primary particle size of 8 to 40 nm and a DBP value of 40 to 200 ml/100 g.

9. The aqueous, colloidal, freeze-resistant and storage stable gas black suspension according to claim 1, wherein carbon black is present having an average primary particle size of 8 to 80 nm and a DBP value of 40 to 200 ml/100 g.

10. The aqueous, colloidal, freeze-resistant and storage stable gas black suspension according to claim 1, wherein the biocide is present in an amount of 0.01 to 1 wt. %.

11. The aqueous, colloidal, freeze-resistant and storage stable gas black suspension according to claim 1, wherein the dispersion-supporting additive is present in an amount of 1 to 50 wt. % based on the total dispersion.

12. An aqueous, colloidal, freeze-resistant and storage-stable gas black suspension, consisting essentially of 2-30 wt. % gas black, 0-40 wt. % carbon black, a dispersion-supporting additive, a biocide and water, and having a zeta potential of less than 10 mV, a surface tension of greater than 50 mN/m and an average particle size of less than 200 nm.

13. The aqueous, colloidal, freeze-resistant and storage-stable gas black suspension according to claim 12, wherein the dispersion-supporting additive is styrene-acrylic acid copolymer.

14. The aqueous, colloidal, freeze-resistant and storage-stable gas black suspension according to claim 13, wherein the styrene-acrylic acid copolymer is completely neutralized with ammonium or alkali hydroxide.

15. An aqueous, colloidal, freeze-resistant and storage-stable gas black suspension, consisting of 2-30 wt. % gas black, 0-40 wt. % carbon black, a dispersion-supporting additive, a biocide and water, and having a zeta potential of less than 10 mV, a surface tension of greater than 50 mN/m and an average particle size of less than 200 nm.

16. The aqueous, colloidal, freeze-resistant and storage-stable gas black suspension according to claim 15, wherein the dispersion-supporting additive is styrene-acrylic acid copolymer.

17. The aqueous, colloidal, freeze-resistant and storage-stable gas black suspension according to claim 16, wherein the styrene-acrylic acid copolymer is completely neutralized with ammonium or alkali hydroxide.

18. The aqueous, colloidal, freeze-resistant and storage stable gas black suspension according to claim 1, which is free of wetting agents.

19. The aqueous, colloidal, freeze-resistant and storage stable gas black suspension according to claim 1, which is free of auxiliary agents for improving suspension properties.

20. A process for producing the aqueous, colloidal, freeze-resistant and storage-stable gas black suspension according to claim 1, comprising dispersing gas black and optionally the carbon black in water together with a dispersion-supporting additive and a biocide.

21. The process for producing the aqueous, colloidal, freeze-resistant and storage-stable gas black suspension according to claim 20, further comprising performing the dispersing with bead mills, ultrasonic devices, high-pressure homogenizers, a microfluidizer, or high intensity mixer.

22. A process of making an ink, inkjet ink, lacquer or printing ink formulation comprising adding the aqueous, colloidal, freeze-resistant and storage-stable gas black suspension according to claim 1 to said formulation.

23. An ink containing the aqueous, colloidal, freeze-resistant and storage-stable gas black suspension according to claim 1.

24. An ink, inkjet ink, lacquer or printing ink composition comprising the aqueous, colloidal, freeze-resistant and storage-stable gas black suspension according to claim 1.

25. An ink comprising the aqueous, colloidal, freeze-resistant and storage-stable gas black suspension according to claim 1 and an ink additive.
